(19) United States
(12) Patent Application Publication
(10) Pub. No.: US 2026/0087153 A1
(43) Pub. Date: Mar. 26, 2026

(54) Data Processing Device and Method for Performing a Cryptographic Algorithm

(71) Applicant: Infineon Technologies AG, Neubiberg (DE)

(72) Inventors: Florian Mendel, München (DE); Srinidhi Hari Prasad, München (DE)

(21) Appl. No.: 19/338,138

(22) Filed: Sep. 24, 2025

(30) Foreign Application Priority Data
Sep. 24, 2024 (DE) 102024209170.7

(51) Int. Cl. G06F 21/60

(52) U.S. Cl. CPC G06F 21/602

(57) ABSTRACT

A cryptographic processing circuit comprises a processing pipeline, with an input circuit configured to feed a state as a first input to the processing circuit for a first round of a sequence of rounds, wherein in each round, the processing circuit processes a second input by a different processing stage than the first input and uses, during each round of one or more of the rounds, a processing result of the second input of a processing stage of the round and/or a processing result of the second input of a processing stage of the preceding round to introduce randomness for a processing of the first input in the round and/or use, during each round of one or more of the rounds, the processing result of the second input of the round for a comparison with a processing result of the first input of the round.

### TECHNICAL FIELD

The present disclosure relates to data processing devices and methods for performing a cryptographic algorithm.

### BACKGROUND

In the context of security-relevant applications, computer chips, such as those on a smart card or in a control device in a vehicle, typically perform cryptographic operations for encryption, decryption and authentication, etc, wherein data is processed, such as cryptographic keys, which are to be protected from access by an attacker. A typical security mechanism is the masking of data to be processed. In particular, for a non-linear operation on one or more numbers, such as multiplying two numbers, the numbers may be randomly split into two (or even more) shares and the operation may be performed using the shares to generate a result which is also represented by two or more shares. Splitting a number into shares may also be seen as masking the number. Masking can protect against attacks like side-channel attacks, logical attacks and spying attacks. Other types of attacks include logic attacks like fault injection, where an attacker alters data (in particular intermediate data of a cryptographic operation such that the cryptographic operation is manipulated, e.g., using a laser) and observes how results change with the altered data, thus gaining information about the processing and for example cryptographic keys used in the processing. Protection against fault injection may be implemented by using redundant processing, where a processing is carried out at least two times to generate multiple processing results and the chip only carries on with further processing if the processing results are equal.

While masking and redundant processing increase robustness against attacks, in particular side-channel attacks and fault injection, chip area is needed for their implementation which may be missing for other functions and thus lead to a reduction of performance. Accordingly, approaches are desirable that allow implementing them with the least chip area and/or performance loss as possible.

### SUMMARY

According to various embodiments, a data processing device is provided comprising a processing circuit configured to perform a cryptographic algorithm comprising processing in a sequence of rounds, wherein the processing circuit comprises a processing pipeline having a sequence of processing stages, wherein each round comprises processing by the processing pipeline, wherein the processing circuit further comprises an input configured to receive a state to be processed and an input circuit configured to feed the state as a first input to the processing circuit for the first round of the sequence of rounds, wherein the processing circuit is configured to process the first input successively in the rounds, wherein it is configured to process the first input in each round successively by the processing stages of the sequence of processing stages, process a second input successively in the rounds, wherein in each round, the processing circuit processes the second input by a different processing stage than the first input and use, during each round of one or more of the rounds, a processing result of the second input of a processing stage of the round and/or a processing result of the second input of a processing stage of the preceding round to introduce randomness for a processing of the first input in the round and/or use, during each round of one or more of the rounds, the processing result of the second input of the round for a comparison with a processing result of the first input of the round.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 shows an example for a processing device.

FIG. 2 illustrates the Ascon encryption scheme.

FIG. 3 illustrates an Ascon S-box.

FIG. 4 illustrates a DOM (domain oriented masking)-indep multiplier of second order.

FIG. 5 illustrates an Ascon round according to a first embodiment.

FIG. 6 illustrates an Ascon round according to a second embodiment.

FIG. 7 illustrates the usage of idle pipeline stages of the Ascon round implementation of FIG. 6 for generation of a pseudo-random number.

FIG. 8 illustrates redundant processing to detect faults.

FIG. 9 illustrates the usage of idle pipeline stages of the Ascon round implementation of FIG. 6 for redundant processing.

FIG. 10 illustrates the usage of idle pipeline stages of the Ascon round implementation of FIG. 6 for redundant processing with one instance of the useful data to be processed being rotated.

FIG. 11 illustrates the usage of idle pipeline stages of the Ascon round implementation of FIG. 6 for redundant processing as well as generation of randomness.

FIG. 12 shows a data processing device according to an embodiment.

FIG. 13 shows a flow diagram illustrating a method for performing a cryptographic algorithm.

### DETAILED DESCRIPTION

The embodiments described herein can be realized by a data processing device like a personal computer, microcontroller, smart card (of any form factor), secure microcontroller, hardware root of trust, (embedded) secure element (ESE), Trusted Platform Module (TPM), or Hardware Security Module (HSM). A data processing device may also refer to a single chip, i.e., an integrated circuit, e.g., implementing a system on chip (SoC).

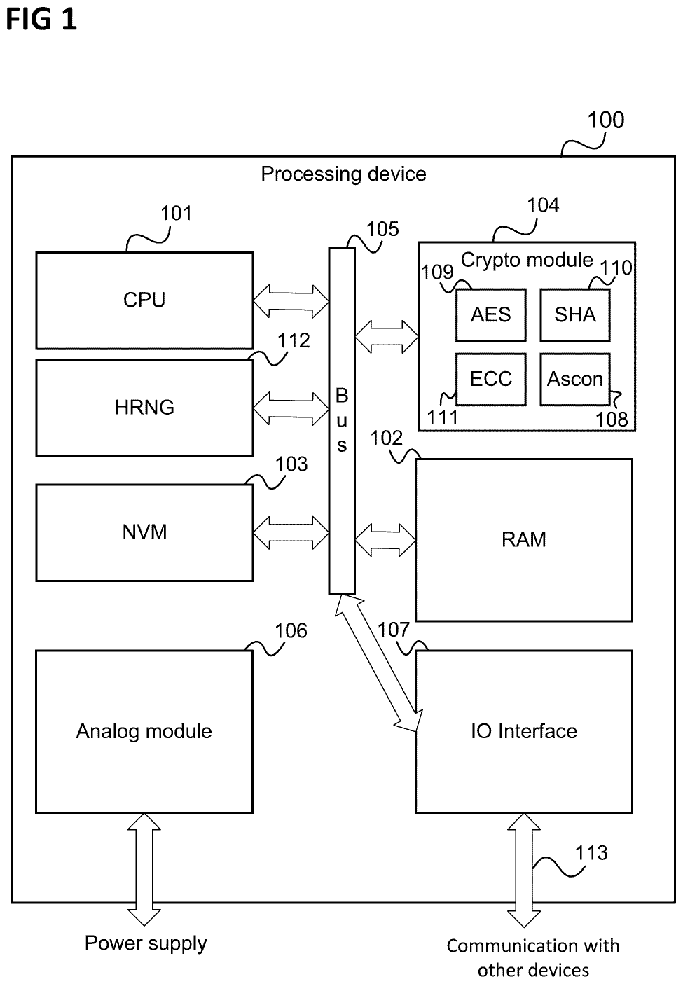

FIG. 1 shows an example for a processing device (e.g., a security controller) 100 including a CPU 101, one or more memories such as a RAM 102 and a non-volatile memory 103 (NVM) or other memories (such as a ROM), a crypto module 104, an analog module 106, an input/output interface 107 and a hardware-random number generator 112.

In this example, the CPU 101 has access to at least one crypto module 104 over a shared bus 105 to which each crypto module 104 is coupled. Each crypto module 104 may in particular include one or more crypto cores to perform certain cryptographic operations. Exemplary crypto cores are:
an AES core 109,
a SHA core 110,
an ECC core 111, and
an Ascon core 108.

The CPU 101, the hardware random number generator 112, the NVM 103, the crypto module 104, the RAM 102 and the input/output interface 107 are connected to the bus 105. The input output interface 107 may have a connection 113 to other devices, which may be similar to the processing device 100.

The analog module 106 is supplied with electrical power via an electrical contact and/or via an electromagnetic field. This power is supplied to drive the circuitry of the processing device 100 and may in particular allow the input/output interface to initiate and/or maintain connections to other devices via the connection 113.

The bus 105 itself may be masked or plain. Instructions for carrying out the processing and algorithms described in the following may in particular be stored in the NVM 103 and processed by the CPU 105. The data processed may be stored in the NVM 103 or in the RAM 102. Supporting functions may be provided by the crypto modules 104 (e.g., expansion of pseudo random data). Random numbers are supplied by the hardware-random number generator 112.

To perform the procedures described in the following, instructions may be stored in the crypto module 104 or they may be provided by the CPU 101 via the bus 105. Data may be stored locally within the crypto module 104. It is also an option that the data is temporarily stored in the RAM 102 or the NVM 103.

The processing and algorithms described in the following may exclusively or at least partially be conducted on the crypto module 104 or on the CPU 101. A processing circuit (such as crypto module 104 or CPU 101) may or may not be equipped with hardware-based security features. Such hardware-based security features could be circuits that implement countermeasures against various attacks such as side-channel power analysis or fault injection (e.g., using a laser), to avoid that an attacker gains information about secret data (such as cryptographic keys or secret user data). Such countermeasures may be realized by the use of randomness, redundant hardware, or redundant processing. In general, the goal of countermeasures is to disguise the internally processed values from an attacker who is able to observe the physical effect the processing of such values.

For the following examples, it is assumed that the processing device 100 carries out a cryptographic algorithm that includes a processing in multiple rounds. An example for this is Ascon. Ascon is a family of authenticated encryption and hashing schemes which all use the same 320-bit permutation, only parameterized by a different number of rounds.

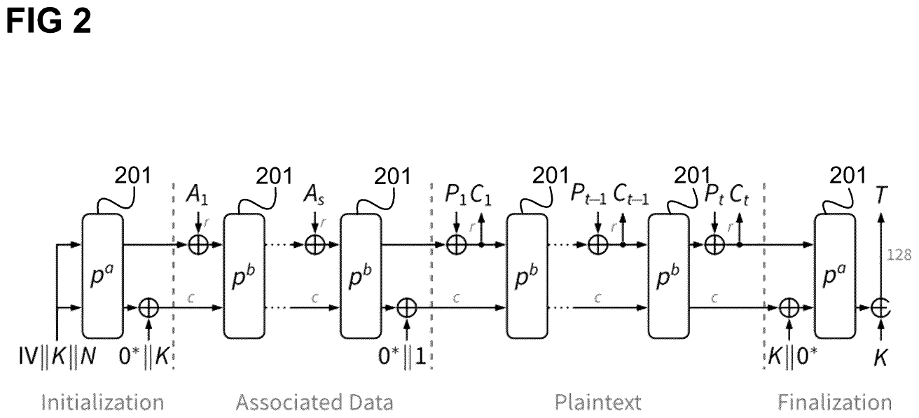

FIG. 2 illustrates the Ascon encryption scheme.

As can be seen, Ascon is based on a sponge construction and includes permutations 201 which include a number of a or b permutation rounds p, i.e., each permutation 201 can be written as p^{a} or p^{b}.

Each permutation stage gets a 320-bit state S as input which is split into five 64-bit registers words (also denoted as state words) xᵢ, i.e.,

$$S = {x}_{0} ‖ {x}_{1} ‖ {x}_{2} ‖ {x}_{3} ‖ {x}_{4}$$

The permutations p^{a} and p^{b} apply a round transformation p iteratively for a and b rounds, respectively. Each round consists of a round constant addition (p_{C}), a substitution layer (p_{S}), and a linear diffusion layer (p_{L}). In the constant addition, a round constant cᵣ is XOR-combined to the register word x₂ of the state (i.e., combined with x₂ according to an XOR combination). The specific value of the round constant depends on the round (i.e., the round index i) of p^{a} and p^{b}. The substitution layer p_{S} is the only non-linear component of the round transformation. It updates the state S with a parallel application of 64 5-bit S-boxes. The S-box is constructed by applying a lightweight linear transformation to the input and an affine layer to the output of the χ mapping of Keccak (i.e., of SHA3). It operates on those five bits with the same bit position in the five state words.

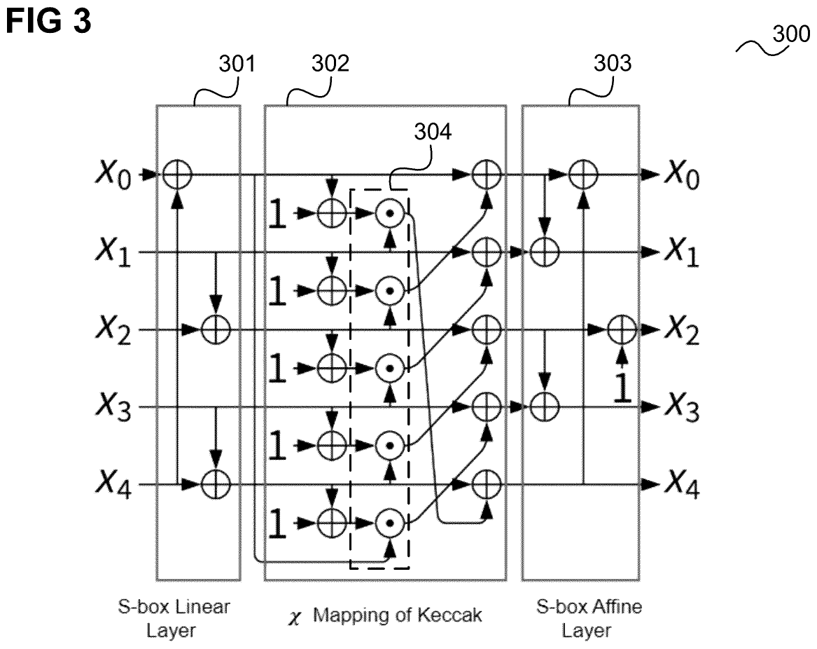

FIG. 3 illustrates an Ascon S-box 300.

As described above, it includes an S-box linear layer 301, a non-linear χ mapping of Keccak 302 and an S-box affine layer 303. The S-box 300 has an algebraic degree of two, a linear and differential branch number of three and can be implemented efficiently in hardware and software.

The linear diffusion layer p_operates on each 64-bit register word xᵢ and applies the linear function Σᵢ(xᵢ) to each register word. It rotates each register word xᵢ by fixed rotation constants and XOR-combines the results with the respective register word:

$${x}_{0} = {\sum }_{0} ( {x}_{0} ) = {x}_{0} ⊕ ( {x}_{0} >>> 19 ) ⊕ ( {x}_{0} >>> 28 )$$

$${x}_{1} = {\sum }_{1} ( {x}_{1} ) = {x}_{1} ⊕ ( {x}_{1} >>> 61 ) ⊕ ( {x}_{1} >>> 39 )$$

$${x}_{2} = {\sum }_{2} ( {x}_{2} ) = {x}_{2} ⊕ ( {x}_{2} >>> 1 ) ⊕ ( {x}_{2} >>> 6 )$$

$${x}_{3} = {\sum }_{3} ( {x}_{3} ) = {x}_{3} ⊕ ( {x}_{3} >>> 10 ) ⊕ ( {x}_{3} >>> 17 )$$

$${x}_{4} = {\sum }_{4} ( {x}_{4} ) = {x}_{4} ⊕ ( {x}_{4} >>> 7 ) ⊕ ( {x}_{4} >>> 41 )$$

According to various embodiments, the processing device 100 carries out a cryptographic algorithm (e.g., an Ascon scheme, i.e., encryption as illustrated in FIG. 2) in a masked manner. Masking is a countermeasure against side-channel attacks, in particular differential power analysis (DPA) which involves statistically analyzing power consumption measurements. The idea of masking is to make intermediate data independent of any sensitive information that is being processed. The most common masking schemes are Boolean masking and arithmetic masking. Boolean masking uses an XOR operation over a binary field in contrast to arithmetic masking, which utilizes addition or multiplication in a modular ring.

Using Boolean masking, d-th order security can be achieved by splitting the secret data into s=d+1 shares using an XOR operation over a binary field. Ideally, each share is then processed individually throughout the computation in a device (e.g., processing device 100). The fundamental principle of domain oriented masking (DOM) is based on shared domains. Here, the objective is to keep the shares of each domain separate from the shares of other domains. For instance, a DOM implementation with d+1 shares for each variable will result in d+1 domains and should provide dth-order security.

There are two types of multipliers using DOM called DOM-indep and DOM-dep. The DOM-indep multiplier operates on independently shared inputs, which has the advantage of requiring less fresh randomness and has a smaller size. The DOM-dep multiplier does not require the inputs to be shared independently but is more costly to implement

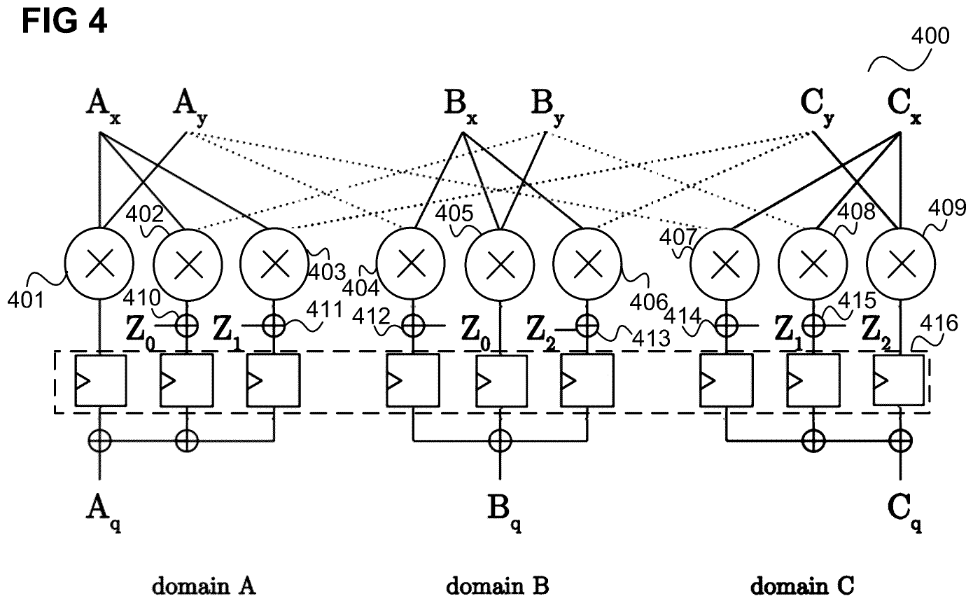

FIG. 4 illustrates the DOM-indep multiplier of second order 400 (i.e., providing second order security) wherein the two operands X and Y are split each into three shares:

$$X = {A}_{X} + {B}_{X} + {C}_{X}$$

$$Y = {A}_{Y} + {B}_{Y} + {C}_{Y}$$

Accordingly, there are three domains A, B, C and the nine products for calculating X*Y (according to the nine possible pairs of one share of X and one share of Y) are performed by nine multipliers 401 to 409. Further, there are three random values Z₀, Z₁ and Z₂ which are added (in different combinations) to results of the multipliers 401 to 409 in the domains A, B and C by adders 410 to 415 for resharing (i.e., remasking).

The addition of the random values Z₀, Z₁ and Z₂ introduces (three bits of) randomness which leads to “fresh random shares” which helps to prevent glitches from crossing the domains. Further, to prevent leaking of information due to glitches, the DOM-indep multiplier includes a register stage 416 (formed by a plurality of flip-flops).

In the present example of Ascon, the DOM-indep multiplier 400 is for example used for the multipliers (i.e., AND gates) 304 of the Keccak χ mapping 302. Due to the register stage 416, this introduces a register stage into the Ascon round. It should be noted that multipliers (in particular DOM-indep multipliers) of other orders may also be used.

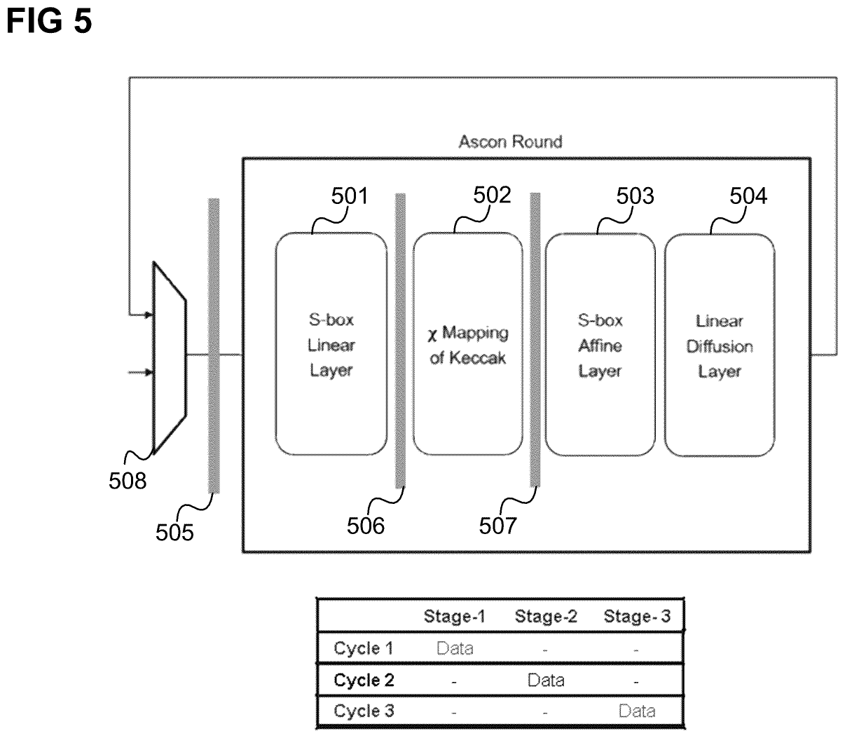

FIG. 5 illustrates an Ascon round according to a first embodiment.

As described above, the Ascon round includes an S-box linear layer 501, a Keccak x mapping 502, an S-box affine layer 503 and a linear diffusion layer 504 (the constant addition is not shown here for simplicity).

The Ascon round includes a first register stage 505 for storing the input to the respective round, a second register stage 506 at the input to the Keccak χ mapping 502 and a third register stage 507 at the end of the Keccak χ mapping 502 which corresponds to the register stage 416 of the DOM-indep multiplier 400 mentioned above.

An input multiplexer 508 (which can be seen as an input circuit of the processing circuit formed by the processing pipeline) allows forwarding the result of a round to the next round or, before the first cycle (e.g., clock cycle) of the first round, input of the state to be permuted.

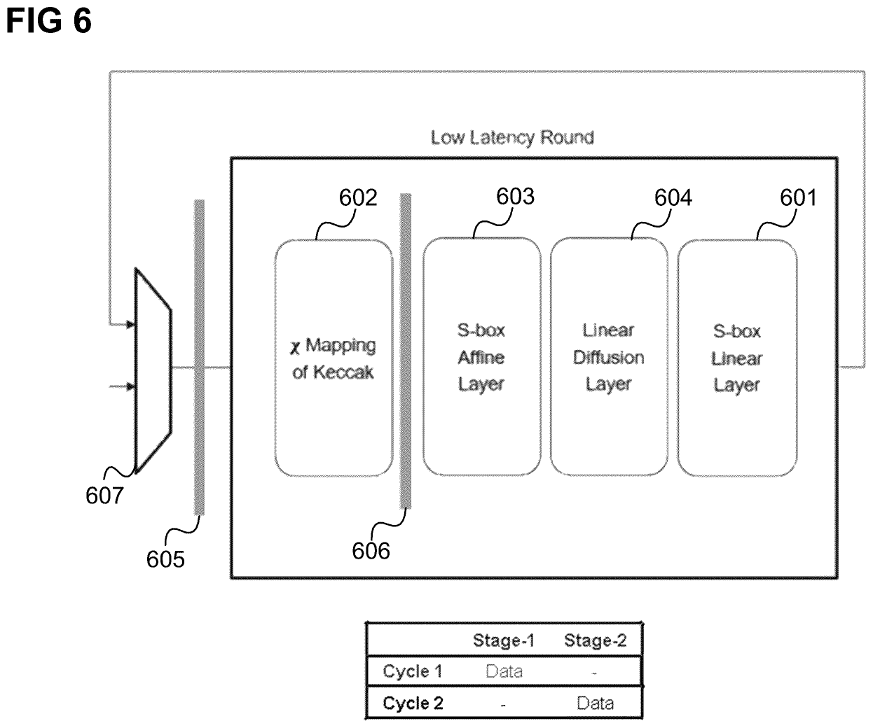

Since each register stage 505, 506, 507 increases latency, it is desirable to keep the number of register stages as low as possible. In fact, it is possible to reduce the number of register states to two as illustrated in FIG. 6 by transforming/preparing the input data accordingly.

FIG. 6 illustrates an Ascon round according to a second embodiment.

Here, the order of the S-box linear layer 601, Keccak χ mapping 602, S-box affine layer 603 and linear diffusion layer 604 is changed which allows removing the second register stage 506 such that only an input register stage 605 and a DOM-indep multiplier register stage 606 remain.

As in FIG. 5, an input multiplexer 607 allows forwarding the result of a round to the next round or, before the first cycle of the first round, inputting the state to be permuted.

So, in the implementation of FIG. 5, each round has a processing pipeline of three processing stages (also referred to as pipeline stages):
Stage-1: processing of S-box linear layer 501
Stage-2: processing of Keccak χ mapping 502
Stage-3: processing of S-box affine layer 503 and processing of linear diffusion layer 504

In the implementation of FIG. 6, each round has a processing pipeline of two processing stages:
Stage-1: processing of Keccak χ mapping 602
Stage-2: processing of S-box affine layer 603, processing of linear diffusion layer 604 and processing of S-box linear layer 601

Accordingly, as illustrated in FIG. 5 and FIG. 6, useful data (i.e., a respective state processed in the respective round) is processed in three cycles or two cycles, respectively, wherein one cycle (e.g., a clock cycle) is the time during which the processing of one processing stage is performed.

For masking, randomness is required. For example, using the DOM-indep multiplier 400, the random values Z₀, Z₁ and Z₂ are needed each round. To generate this randomness (i.e., provide random numbers), a dedicated random number generator like the hardware-random number generator 112 can be provided which, however, result in a significant performance degradation and/or higher chip area.

Therefore, according to various embodiments, unused (i.e., idle) pipeline stages are used in a masked implementation of a cryptographic algorithm as pseudo-random number generator (PRNG). This is described in the following for the Ascon round implementation of FIG. 6 with two cycles per round but may be analogously applied to rounds with more cycles (like the Ascon round implementation of FIG. 5) or rounds of any other cryptographic algorithm which has multiple cycles and is implemented in a masked manner such as SHA3 (Secure Hash Algorithm 3) and AES (Advanced Encryption Standard).

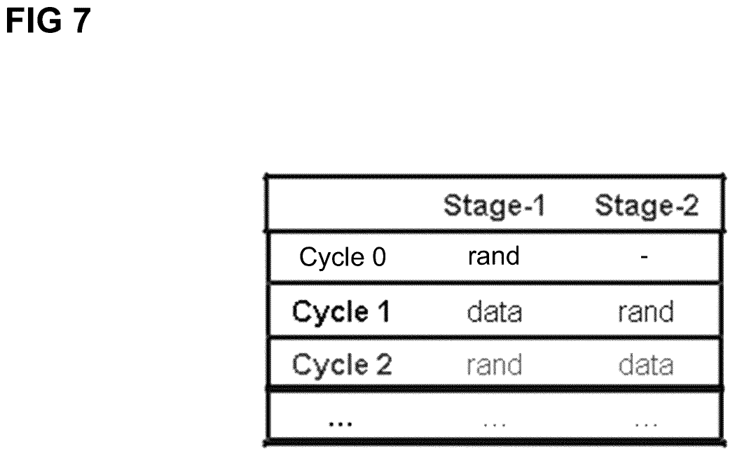

FIG. 7 illustrates the usage of idle pipeline stages of the Ascon round implementation of FIG. 6 for generation of a pseudo-random number.

As explained above, each round has two cycles. For the following explanation, it is assumed that Cycle 1 is the first cycle of the first round, Cycle 2 is the second cycle of the first round, Cycle 3 is the first cycle of the second round and so on.

For random number generation, before Cycle 1, an initial random number is introduced via the input multiplexer 607 and is processed by the first processing stage in a “Cycle 0” by the Keccak χ mapping 602. This initial random number can be seen as a seed and since it is needed only once for the whole permutation (i.e., for all of the a or b rounds), it can be generated with small implementation overhead.

For Cycle 1, the state to be processed is introduced via the input multiplexer 607. This is then processed in Cycle 1 by the Keccak χ mapping 602 as usual, wherein, however the result of Cycle 0, i.e., the random number as it results from the processing of the initial random number by the Keccak χ mapping 602 is used as the needed randomness for the masked implementation of the χ mapping, i.e., for the random values Z₀, Z₁ and Z₂. For example, parts of the Cycle 0 processing result may be taken for the Z₀, Z₁ and Z₂. Further, in Cycle 1, the random number is further processed by the second processing stage (i.e., by S-box affine layer 603, linear diffusion layer 604 and S-box linear layer 601).

Then, the processing continues in the usual manner wherein, however, a processing stage which does presently not process the useful data (i.e., the state) processes the random number. For example, in Cycle 2, the second processing stage processes the useful data while the first processing stage processes the random number, which is the result of the Stage-2 processing of the random number of Cycle 1.

In other words, each processing stage alternatingly processes the useful data (i.e., the state to be permuted) and the random number such that both the useful data and the random number pass through the whole permutation (i.e., all rounds) wherein each time the useful data is processed by the first processing stage (i.e., in an odd-numbered cycle), the current version of the random number is used to provide the needed randomness. Thus, a masked implementation can be realized with small implementation overhead in terms of chip area and performance.

Masking can protect against side-channel attacks. Another type of attack is fault injection, where an attacker alters the computation and/or intermediate data (e.g., using a laser) and observes how results change with the altered data, thus gaining information about the processing and for example cryptographic keys used in the processing. Protection against fault injection may be implemented by using redundant processing.

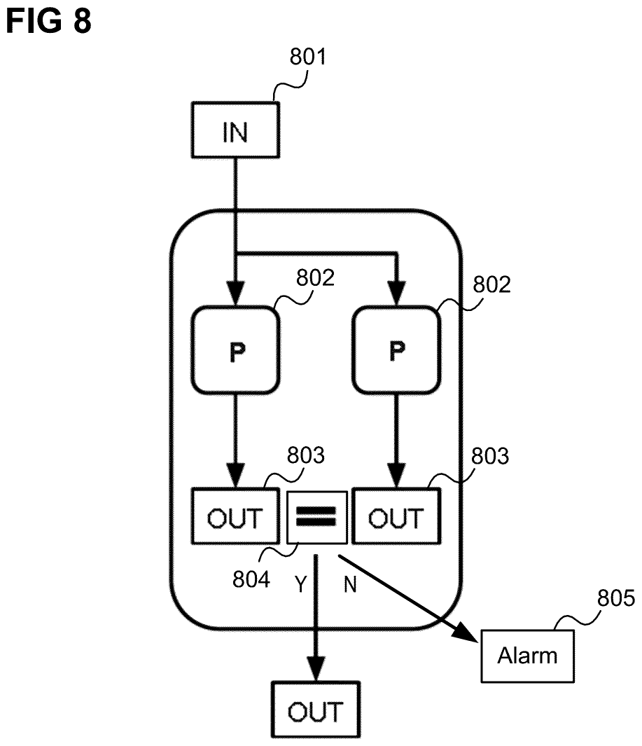

FIG. 8 illustrates redundant processing to detect faults (in particular faults introduced by fault attacks).

In redundant processing, an input 801 is processed by (at least) two processing blocks 802 which carry out the same processing. The results 803 of the two processing blocks 802 are then compared by a comparator 804. If they are equal (or, depending on the use case, sufficiently close to each other) they are output as (single) processing result. If they are not equal, the comparator outputs an alarm signal 805, i.e., triggers an alarm (e.g., processing of the respective chip is stopped, thus preventing an attacker from gaining information from differences occurring in further processing caused by an injected fault). For a successful fault attack, an attacker now would have to introduce the same fault in both processing blocks 802, which is much harder than introducing a single fault.

In the present use case, the input 801 is a state, e.g., the state at the beginning of the permutation (i.e., before the first round) or the state after one or more rounds (i.e., the input to a certain round after one or more rounds have already been performed).

Performing redundant processing increases the chip area needed because processing blocks needed to be implemented multiple times.

Therefore, according to various embodiments, unused (i.e., idle) pipeline stages are used for redundant processing (i.e., for a second version of the useful data), i.e., the processing blocks 802 are both implemented by the pipeline stages by using them in an alternating manner. This is described in the following for the Ascon round implementation of FIG. 6 with two cycles per round but may be analogously applied to rounds with more cycles (like the Ascon round implementation of FIG. 5) or rounds of any other cryptographic algorithm which has multiple cycles.

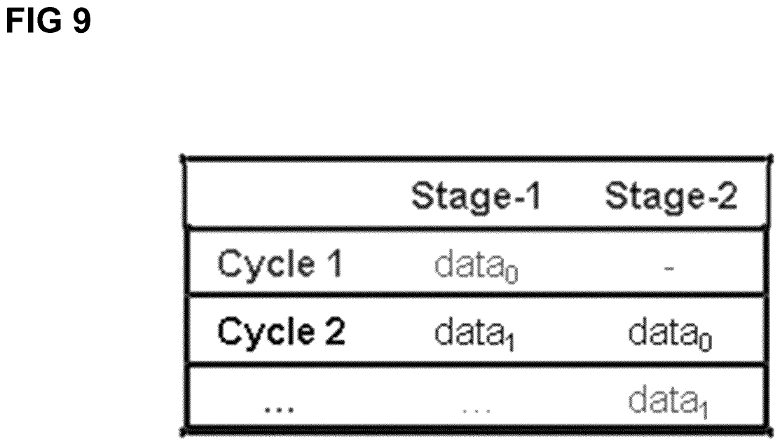

FIG. 9 illustrates the usage of idle pipeline stages of the Ascon round implementation of FIG. 6 for redundant processing.

As explained above, each round has two cycles. For the following explanation, it is assumed that Cycle 1 is the first cycle of the first round, Cycle 2 is the second cycle of the first round, Cycle 3 is the first cycle of the second round and so on.

For redundant processing, two instances of the state to be processed, denoted by data₀ and data₁ are processed in parallel in the different pipeline stages.

For Cycle 1, the first instance the state to be processed (data₀) is introduced via the input multiplexer 907. This is then processed in Cycle 1 by the first processing stage as usual and then processed in Cycle 2 by the second processing stage as usual.

However, for Cycle 2, the second instance the state to be processed (data₁) is processed by the first processing stage.

For Cycle 3, the result of the stage 2 processing of data₀ (of Cycle 2) is fed back to the first processing stage via the input multiplexer 907 and is (further) processed by the first processing stage while the result of the stage 1 processing of data₁ (of Cycle 2) is (further) processed by the second processing stage.

Thus, the processing continues in the usual manner wherein, each processing stage alternatingly processes the first instance and the second instance of the useful data (in each cycle, i.e., it is never idle).

In other words, each processing stage alternatingly processes the two instances of the useful data (i.e., the state to be permuted) such that both instances pass through the whole permutation (i.e., all rounds)

At some point of the processing, the processing results of the two instances are compared by a comparator (e.g., comparator 804), wherein the comparator needs to store the data₀ processing result needs for one cycle until it has obtained the corresponding data₁ processing result. This can be done at the end of the permutation but also during the processing, e.g., after a certain number of rounds.

By using the processing stages to process both instances of the data, redundant processing can be realized with small implementation overhead in terms of chip area as well as very small latency increase (only one cycle).

It should be noted that the approach of FIG. 9 only provides redundancy in the temporal domain since if an attacker arrives at injecting the same fault in two consecutive cycles the two instances have the fault at the same position which cannot be detected by the comparator.

To also achieve spatial redundancy, according to various embodiments, one of the instances is rotated.

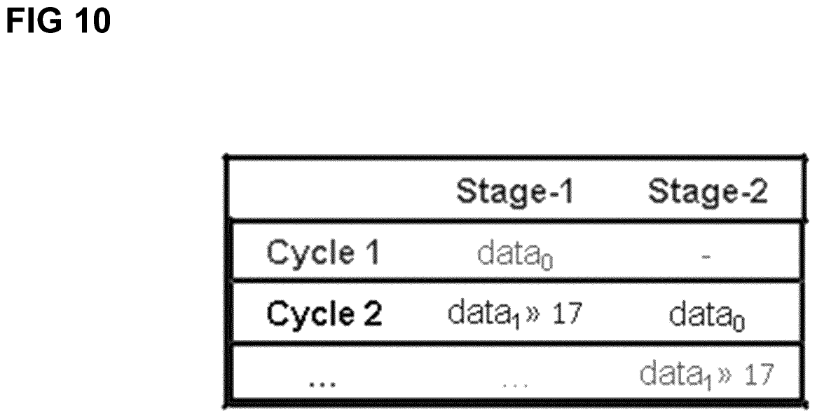

FIG. 10 illustrates the usage of idle pipeline stages of the Ascon round implementation of FIG. 6 for redundant processing with one instance of the useful data to be processed being rotated.

The approach is similar to the one described with reference to FIG. 9, but the second instance of the useful data (data₁) is now rotated with respect to the other instance by a predetermined number of bits, in this example 17 bits. Other numbers are possible but a number being coprime to the state length (or at least to the word length) may be preferable.

This approach makes use of (internal) rotational symmetry present in Ascon and may be used for other algorithms with rotational symmetry which are very common in cryptography to enable efficient implementations.

The comparator compensates the rotation (e.g., rotates the processing backwards of the data₁ processing result by the predetermined number) and then performs the comparison.

With the approach of FIG. 10 the comparator may detect an injected fault even if an attacker arrives at injecting the same fault in two consecutive cycles since the processing results of the two useful data instances have the fault at the different positions. Multi-bit faults (laser spot) will cancel out only with low probability.

It should be noted that the processing for the rotated data instance may be needed to be slightly adapted such that the processing results of the two instances are the same (if no faults occur). Specifically, in case of Ascon, a round constant cᵣ needs also to be rotated to perform the correct round processing. In fact, round constants are typically used to break symmetries, e.g., in Ascon, SHA3, and AES. Still, only small changes are needed in the hardware to implement the approach of FIG. 10 (e.g., to rotate the round constants to achieve the same processing for the two instances).

It should further be noted that redundant processing approach of FIG. 9 or FIG. 10 may be combined with the approach of FIG. 7 for random number generation to reduce the cost for generating randomness. For example, random shares of the second data instance data₁ may be used as randomness for data₀ and vice versa.

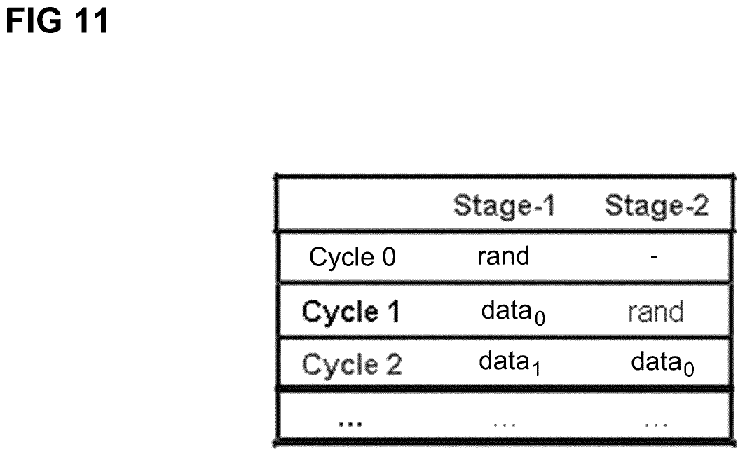

FIG. 11 illustrates the usage of idle pipeline stages of the Ascon round implementation of FIG. 6 for redundant processing as well as generation of randomness.

As explained with reference to FIG. 7, before Cycle 1, an initial random number is introduced via the input multiplexer 607 and is processed by the first processing stage in a “Cycle 0” by the Keccak χ mapping 602. This initial random number can be seen as a seed and since it is needed only once for the whole permutation (i.e., for all of the a or b rounds), it can be generated with small implementation overhead.

The result of the Cycle 0 processing is then used as randomness (e.g., as the Zᵢ) for the processing of the first instance of the useful data data₀ in the first processing stage (Cycle 1). For the processing of the second instance of the useful data data₁ in Cycle 2 the result of the processing of data in Cycle 1 is used for randomness (e.g., for the Zᵢ). Similarly, in all the following rounds, the processing result of data₀ (first processing stage) is used as randomness (e.g., the Zᵢ) for data₁ and vice versa.

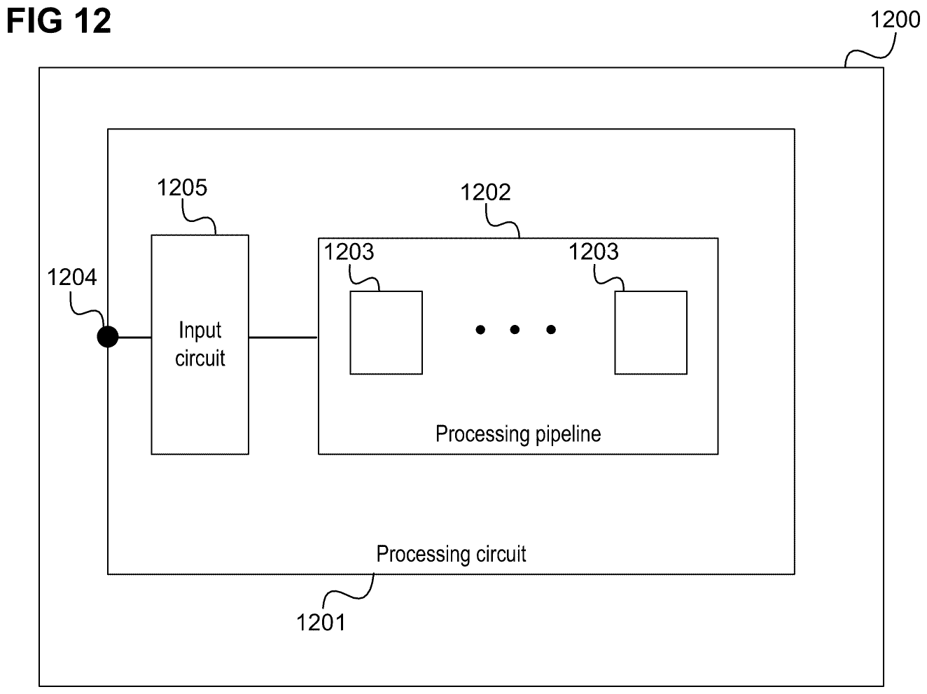

In summary, according to various embodiments, a data processing device is provided as illustrated in FIG. 12.

FIG. 12 shows a data processing device 1200 according to an embodiment.

The data processing device comprises a processing circuit 1201 configured to perform a cryptographic algorithm comprising processing in a sequence of rounds, wherein the processing circuit comprises a processing pipeline 1202 having a sequence of processing stages 1203, wherein each round comprises processing by the processing pipeline 1202. Processing stages are for example blocks of processing separated by registers, i.e., by storage elements (typically flip-flops).

The processing circuit 1201 further comprises an input 1204 configured to receive a state to be processed and an input circuit 1205 configured to feed the state as a first input to the processing circuit for the first round of the sequence of rounds.

The processing circuit 1201 is configured to
process the first input successively in the rounds, wherein it is configured to process the first input in each round successively by the processing stages 1203 of the sequence of processing stages 1203,
process a second input successively in the rounds, wherein in each round, the processing circuit 1201 processes the second input by a different processing stage 1203 than the first input; and
use, during each round of one or more of the rounds, a processing result of the second input of a processing stage of the round and/or a processing result of the second input of a processing stage of the preceding round (i.e., a round directly preceding the round in the sequence of rounds) to introduce randomness for a processing of the first input in the round (the processing stage of the round or the preceding round may for example be a processing stage after the processing stage into which randomness is introduced in the sequence of processing stages—for example, a result generated with the second processing stage may be used as randomness for the first processing stage) and/or
use, during each round of one or more of the rounds, the processing result of the second input of the round for a comparison with a processing result of the first input of the round.

According to various embodiments, in other words second input data is processed along with useful data in rounds wherein for processing the second input processing stages which are currently not occupied by the first data are used (e.g., in case of two states each processing stage alternatingly processes the first input and the second input). Results of the processing of the second input is used for introducing randomness (to protect against side-channel attacks) and/or as comparative result for a comparison with a result of the processing of the first input (for redundant processing, e.g., to protect against fault injection attacks or to increase safety).

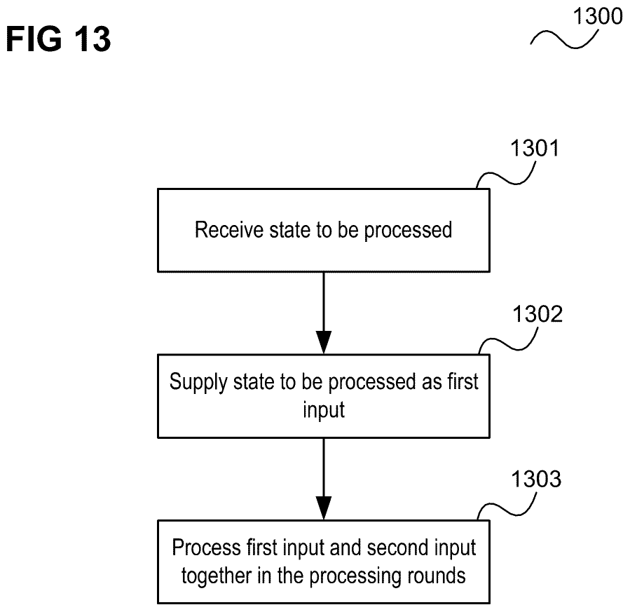

According to various embodiments, a method is performed as illustrated in FIG. 13.

FIG. 13 shows a flow diagram 1300 illustrating a method for performing a cryptographic algorithm according to an embodiment. The cryptographic algorithm comprises processing in a sequence of rounds, each round comprising processing by a processing pipeline having a sequence of processing stages.

In 1301, a state to be processed is received.

In 1302, the state is fed as a first input to the first round of the sequence of rounds.

In 1303, the first input is processed successively in the rounds (i.e., sequentially by the rounds, first by the first round, then the result of the first round by the second round etc.), wherein the first input is processed in each round successively by the processing stages of the sequence of processing stages (i.e., sequentially by the processing stages, i.e., it passes through the sequence of processing stages) and a second input is processed successively in the rounds, wherein in each round, the second input is processed by a different processing stage than the first input.

During each round of one or more of the rounds, a processing result of the second input of a processing stage of the round or of a processing stage of the preceding round is used to introduce randomness for a processing of the first input in the round and/or a processing result of the second input of the round is used for a comparison with a processing result of the first input of the round.

The method of FIG. 13 may be performed by one or more data processing devices (e.g., computers or microcontrollers) having one or more data processing units. The term “data processing unit” may be understood to mean any type of entity that enables the processing of data or signals. For example, the data or signals may be handled according to at least one (i.e., one or more than one) specific function performed by the data processing unit. A data processing unit may include or be formed from an analog circuit, a digital circuit, a logic circuit, a microprocessor, a microcontroller, a central processing unit (CPU), a graphics processing unit (GPU), a digital signal processor (DSP), a field programmable gate array (FPGA), or any combination thereof. Any other means for implementing the respective functions described in more detail herein may also be understood to include a data processing unit or logic circuitry. One or more of the method steps described in more detail herein may be performed (e.g., implemented) by a data processing unit through one or more specific functions performed by the data processing unit.

Some or all of the components of the data processing device described with reference to FIG. 12, i.e., the processing circuit 1201, the processing pipeline 1202, the processing stages 1203 and/or the input circuit 1204, may be implemented as hardware circuits, i.e., as logic gates and storage elements (e.g., flip-flops) which are connected together to perform the various functions (i.e., without the need to program them).

Various Examples are described in the following:

Example 1 is a data processing device as described with reference to FIG. 12.

Example 2 is the data processing device of example 1, wherein the processing circuit is configured to use the processing result of the second input of the processing stage of the round or the processing result of the second input of the processing stage of the preceding round for a re-masking of an intermediate result of the processing of the first input (i.e., using the processing result of the second input to introduce randomness for the processing of the first input comprises using the processing result of the second input for a re-masking of an intermediate result of the processing of the first input).

Example 3 is the data processing device of example 1 or 2, wherein the processing circuit is configured to use the processing result of the second input of the processing stage of the round or the processing result of the second input of the processing stage of the preceding round as randomness for the implementation of a masked AND-gate.

Example 4 is the data processing device of any one of examples 1 to 3, wherein the second input is a random value (for the case that the processing result of the second input of a processing stage of the round or of a processing stage of the preceding round is used to introduce randomness for the processing of the first input in the round).

Example 5 is the data processing device of any one of examples 1 to 3, wherein the second input is the state to be processed (this may be done for both cases: introduce randomness and for using the processing result of the second input for the comparison).

Example 6 is the data processing device of any one of examples 1 to 3, wherein the second input is a permuted (e.g., rotated) version of the state to be processed (this may be done for both cases: introduce randomness and for using the processing result of the second input for the comparison; the processing circuit or the input circuit may be configured to perform the rotation).

Example 7 is the data processing device of example 6, wherein the processing circuit is configured to adjust the processing of the second input to compensate for the permutation of the second input with respect to the first input (e.g., permutate a constant which is added in the same manner).

Example 8 is the data processing device of example 6 or 7, wherein the second input is rotated by a predetermined number of bits with respect to the state to be processed and adjusting the round comprises rotating a constant which is added in the processing by the round by the predetermined number of bits.

Example 9 is the data processing device of any one of examples 1 to 8, wherein the processing circuit is configured to use the processing result of the second input of the round for a comparison with the processing result of the first input of the round and to output an alarm in case of a mismatch of the processing result of the second input of the round and the processing result of the first input of the round.

Example 10 is the data processing device of any one of examples 1 to 9, wherein the sequence of rounds implements a (cryptographic) permutation (of its input).

Example 11 is the data processing device of any one of examples 1 to 10, wherein the cryptographic algorithm is a hashing, an encryption or a decryption algorithm.

Example 12 is a method for performing a cryptographic algorithm as described with reference to FIG. 13.

The examples described herein provide efficient approaches for increasing the security of processing of secret data like cryptographic keys, in particular for protecting against side-channel attacks and fault injection attacks.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims, embodiments and examples may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

1. A data processing device comprising:
a processing circuit configured to perform a cryptographic algorithm comprising processing in a sequence of rounds, wherein the processing circuit comprises a processing pipeline having a sequence of processing stages, wherein each round comprises processing by the processing pipeline;
wherein the processing circuit further comprises
an input configured to receive a state to be processed and an input circuit configured to feed the state as a first input to the processing circuit for the first round of the sequence of rounds;
wherein the processing circuit is configured to
process the first input successively in the rounds, wherein it is configured to process the first input in each round successively by the processing stages of the sequence of processing stages;
process a second input successively in the rounds, wherein in each round, the processing circuit processes the second input by a different processing stage than the first input; and
use, during each round of one or more of the rounds, a processing result of the second input of a processing stage of the round and/or a processing result of the second input of a processing stage of the preceding round to introduce randomness for a processing of the first input in the round and/or
use, during each round of one or more of the rounds, the processing result of the second input of the round for a comparison with a processing result of the first input of the round.

2. The data processing device of claim 1, wherein the processing circuit is configured to use the processing result of the second input of the processing stage of the round or the processing result of the second input of the processing stage of the preceding round for a re-masking of an intermediate result of the processing of the first input.

3. The data processing device of claim 1, wherein the processing circuit is configured to use the processing result of the second input of the processing stage of the round or the processing result of the second input of the processing stage of the preceding round as randomness for the implementation of a masked AND-gate.

4. The data processing device of claim 1, wherein the second input is a random value.

5. The data processing device of claim 1, wherein the second input is the state to be processed.

6. The data processing device of claim 1, wherein the second input is a permuted version of the state to be processed.

7. The data processing device of claim 6, wherein the processing circuit is configured to adjust the processing of the second input to compensate for the permutation of the second input with respect to the first input.

8. The data processing device of claim 6, wherein the second input is rotated by a predetermined number of bits with respect to the state to be processed and adjusting the round comprises rotating a constant which is added in the processing by the round by the predetermined number of bits.

9. The data processing device of claim 1, wherein the processing circuit is configured to use the processing result of the second input of the round for a comparison with the processing result of the first input of the round and to output an alarm in case of a mismatch of the processing result of the second input of the round and the processing result of the first input of the round.

10. The data processing device of claim 1, wherein the sequence of rounds implements a permutation of its input.

11. The data processing device of claim 1, wherein the cryptographic algorithm is a hashing, an encryption or a decryption algorithm.

12. A method for performing a cryptographic algorithm comprising processing in a sequence of rounds, each round comprising processing by a processing pipeline having a sequence of processing stages, the method comprising:
receiving a state to be processed;
feeding the state as a first input to the first round of the sequence of rounds;
processing the first input successively in the rounds, wherein the first input is processed in each round successively by the processing stages of the sequence of processing stages;
processing a second input successively in the rounds, wherein in each round, the second input is processed by a different processing stage than the first input;
and wherein, during each round of one or more of the rounds, a processing result of the second input of a processing stage of the round or of a processing stage of the preceding round is used to introduce randomness for a processing of the first input in the round and/or a processing result of the second input of the round is used for a comparison with a processing result of the first input of the round.

13. The method of claim 12, further comprising using the processing result of the second input of the processing stage of the round or the processing result of the second input of the processing stage of the preceding round for a re-masking of an intermediate result of the processing of the first input.

14. The method of claim 12, further comprising using the processing result of the second input of the processing stage of the round or the processing result of the second input of the processing stage of the preceding round as randomness for the implementation of a masked AND-gate.

15. The method of claim 12, wherein the second input is a random value.

16. The method of claim 12, wherein the second input is the state to be processed.

17. The method of claim 12, wherein the second input is a permuted version of the state to be processed.

18. The method of claim 17, further comprising adjusting the processing of the second input to compensate for the permutation of the second input with respect to the first input.

19. The method of claim 6, wherein the second input is rotated by a predetermined number of bits with respect to the state to be processed and adjusting the round comprises rotating a constant which is added in the processing by the round by the predetermined number of bits.

20. The method of claim 1, further comprising using the processing result of the second input of the round for a comparison with the processing result of the first input of the round and outputting an alarm in case of a mismatch of the processing result of the second input of the round and the processing result of the first input of the round.
